(19) United States
(12) Patent Application Publication
(10) Pub. No.: US 2014/0011095 A1
(43) Pub. Date: Jan. 9, 2014

(54) ORGANIC/INORGANIC HYBRID ELECTROLYTE, METHODS FOR PREPARING THE SAME, AND LITHIUM BATTERY INCLUDING THE SAME

(71) Applicant: Electronics and Telecommunications Research Institute, (US)

(72) Inventors: Young-Gi LEE, Daejeon (KR); Kwang Man Kim, Daejeon (KR); Kunyoung Kang, Daejeon (KR); Dong Ok Shin, Daejeon (KR)

(73) Assignee: Electronics and Telecommunications Research Institute, Daejeon (KR)

(21) Appl. No.: 13/845,990

(22) Filed: Mar. 18, 2013

(30) Foreign Application Priority Data
Jul. 3, 2012 (KR) 10-2012-0072358
Dec. 12, 2012 (KR) 10-2012-0144263

(51) Int. Cl. H01M 10/056; H01M 10/052

(52) U.S. Cl. CPC H01M 10/056; H01M 10/052
USPC 429/309; 429/188; 429/200

(57) ABSTRACT

An organic/inorganic hybrid electrolyte includes inorganic particles, a first polymer surrounding the inorganic particles, a second polymer having a network structure and surrounding the first polymer, and an organic solution. In the organic/inorganic hybrid electrolyte, ions may be transferred to the organic solution through the first polymer and/or the second polymer. As the inorganic particles are distributed to be provided, they may be involved in transferring ions in the organic/inorganic hybrid electrolyte. The organic/inorganic hybrid electrolyte may have high ionic conductivity while ensuring stability and mechanical strength.

### CROSS-REFERENCE TO RELATED APPLICATIONS

This US non-provisional patent application claims priority under 35 USC §119 to Korean Patent Application Nos. 10-2012-0072358, filed on Jul. 3, 2012, and 10-2012-0144263, filed on Dec. 12, 2012, the entirety of which is hereby incorporated by reference.

### BACKGROUND OF THE INVENTION

Exemplary embodiments of the inventive concepts relate to lithium batteries and, more particularly, to organic/inorganic hybrid electrolytes for lithium batteries.

With the increasing importance of energy storage and conversion technologies, there is considerable interest in lithium batteries. Since lithium batteries are much higher in energy density than other batteries and are made compact and light, there is a high possibility of using the lithium batteries as power sources for portable electronic devices. A lithium battery may include an anode, a cathode, and an electrolyte.

A carbonate-based solvent containing dissolved lithium salt (LiPF₆) is widely used as an organic liquid electrolyte. The organic liquid electrolyte has superior electrochemical properties due to very high mobility of lithium ions. However, the organic liquid electrolyte suffers from stability problems caused by high combustibility, volatility, and liquid leakage.

An inorganic solid electrolyte may ensure stability and mechanical strength. An oxide-based solid electrolyte or a sulfide-based solid electrolyte is widely used as an inorganic solid electrolyte. Since the oxide-based solid electrolyte causes grain boundary resistance, the oxide-based solid electrolyte cannot be implemented without being prepared in the form of bulk. A sulfide-based solid electrolyte has superior ionic conductivity, but can be prepared only under an inert atmosphere because of its sensitiveness to moisture. Thus, various studies have been conducted on electrolytes for lithium batteries.

### SUMMARY OF THE INVENTION

Exemplary embodiments of the inventive concepts provide an organic/inorganic hybrid electrolyte, a method for preparing the same, and a lithium battery including the same.

An organic/inorganic hybrid electrolyte according to the inventive concepts may include a first polymer surrounding distributed inorganic particles, a second polymer having a network structure where chains are entangled and intersect each other, and an organic solution supplied between the first polymer and the second polymer, wherein the second polymer surrounds and binds the first polymer.

In an exemplary embodiment, the inorganic particles may include a first particle and a second particle that are spaced apart from each other.

In an exemplary embodiment, the inorganic particles may be in contact with at least one of the first polymer and the organic solution.

In an exemplary embodiment, the first polymer may be in contact with the inorganic particles and the second polymer and connect the inorganic to the second polymer.

In an exemplary embodiment, the first polymer includes a vinylidene fluoride-based polymer, a copolymer of vinylidene fluoride and hexafluoropropylene, a copolymer of vinylidene fluoride and trifluoro ethylene or a copolymer of vinylidene fluoride and tetrafluoroethylene, and the second polymer may include cellulose, cellulose, ethyl cellulose, butyl cellulose, carboxymethyl cellulose or hydroxypropyl cellulose.

In an exemplary embodiment, the organic solution may include lithium salt and an organic solvent.

A method for preparing an organic/inorganic hybrid electrolyte according to the inventive concepts may include preparing a first mixture by mixing a first polymer with an organic solution containing dissolved lithium salt, preparing a second mixture by adding organic particles to the first mixture, preparing an electrolyte paste by adding a second polymer to the second mixture, and forming an electrolyte film by coating the electrolyte paste on a substrate, wherein the second polymer has a network structure where chains intersect each other and binds the first polymer.

In an exemplary embodiment, the inorganic particles may be distributed in the first polymer and may be in contact with at least one of the first polymer and the organic solution.

In an exemplary embodiment, preparing an electrolyte paste may include filling the organic solution containing the dissolved lithium salt in between the first polymer and the second polymer.

In an exemplary embodiment, the second mixture may have higher viscosity than the first mixture.

In an exemplary embodiment, preparing an electrolyte paste may include mixing a second polymer such that the first polymer and the second polymer have a weight ratio of 1:99 to 99:1.

In an exemplary embodiment, the inorganic particles may be added to have 1 to 2000 percent by weight to the first polymer and the second polymer, and the organic solution containing the dissolved lithium salt may be added to have 1 to 800 percent by weight to the first polymer and the second polymer.

A lithium battery according to the inventive concepts may include an anode, a cathode spaced to face the anode, and an organic/inorganic hybrid electrolyte disposed between the anode and the cathode, wherein the organic/inorganic hybrid electrolyte may include inorganic particles including a first particle and a second particle that are spaced apart from each other, a vinylidene fluoride-based polymer surrounding the inorganic particles, a cellulose-based polymer having a network structure where chains are entangled and surrounding and binding the vinylidene fluoride-based polymer, and an organic solution containing dissolved lithium salt filled in between the vinylidene fluoride-based polymer and the cellulose-based polymer.

In an exemplary embodiment, the inorganic particles may be in contact with at least one of the cellulose-based polymer and the organic solution containing the dissolved lithium salt.

In an exemplary embodiment, the cellulose-based polymer may connect the inorganic particles to the vinylidene fluoride-based polymer.

In an exemplary embodiment, the organic solution containing the dissolved lithium salt may be further filled in between the inorganic particles and the vinylidene fluoride-based polymer and between the inorganic particles and the cellulose-based polymer.

In an exemplary embodiment, the organic/inorganic hybrid electrolyte may be provided in the form of film.

In an exemplary embodiment, the vinylidene fluoride-based polymer may include a vinylidene fluoride-based polymer, a copolymer of vinylidene fluoride and hexafluoropropylene, a copolymer of vinylidene fluoride and trifluoro ethylene or a copolymer of vinylidene fluoride and tetrafluoroethylene, and the cellulose-based polymer may include cellulose, cellulose, ethyl cellulose, butyl cellulose, carboxymethyl cellulose or hydroxypropyl cellulose.

### BRIEF DESCRIPTION OF THE DRAWINGS

The inventive concept will become more apparent in view of the attached drawings and accompanying detailed description. The embodiments depicted therein are provided by way of example, not by way of limitation, wherein like reference numerals refer to the same or similar elements. The drawings are not necessarily to scale, emphasis instead being placed upon illustrating aspects of the inventive concept.

FIG. 1 is a cross-sectional view of a lithium battery according to an embodiment of the inventive concept.

FIG. 2 is a cross-sectional view of an organic/inorganic hybrid electrolyte according to an embodiment of the inventive concept.

FIG. 3 is an enlarged view of a Z region in FIG. 2.

FIG. 4 is a flowchart illustrating a method for preparing an organic/inorganic hybrid electrolyte according to an embodiment of the inventive concept.

FIG. 5 is a graph showing a result of evaluating ionic conductivity characteristics of the test example and the comparison example.

### DETAILED DESCRIPTION

The advantages and features of the inventive concept and methods of achieving them will be apparent from the following exemplary embodiments that will be described in more detail with reference to the accompanying drawings. It should be noted, however, that the inventive concept is not limited to the following exemplary embodiments, and may be implemented in various forms. Accordingly, the exemplary embodiments are provided only to disclose the inventive concept and let those skilled in the art know the category of the inventive concept.

In the specification, it will be understood that when an element is referred to as being “on” another layer or substrate, it can be directly on the other element, or intervening elements may also be present. In the drawings, thicknesses of elements are exaggerated for clarity of illustration.

Exemplary embodiments of the invention will be described below with reference to cross-sectional views, which are exemplary drawings of the invention. The exemplary drawings may be modified by manufacturing techniques and/or tolerances. Accordingly, the exemplary embodiments of the invention are not limited to specific configurations shown in the drawings, and include modifications based on the method of manufacturing the semiconductor device. For example, an etched region shown at a right angle may be formed in a rounded shape or formed to have a predetermined curvature. Therefore, regions shown in the drawings have schematic characteristics. In addition, the shapes of the regions shown in the drawings exemplify specific shapes of regions in an element, and do not limit the invention. Though terms like a first, a second, and a third are used to describe various elements in various embodiments of the inventive concept, the elements are not limited to these terms. These terms are used only to tell one element from another element. An embodiment described and exemplified herein includes a complementary embodiment thereof.

The terms used in the specification are for the purpose of describing particular embodiments only and are not intended to be limiting of the invention. As used in the specification, the singular forms “a”, “an” and “the” are intended to include the plural forms as well, unless the context clearly indicates otherwise. It will be further understood that the terms “comprises” and/or “comprising”, when used in the specification, specify the presence of stated features, integers, steps, operations, elements, and/or components, but do not preclude the presence or addition of one or more other features, integers, steps, operations, elements, components, and/or groups thereof.

Hereinafter, organic/inorganic hybrid electrolytes and lithium batteries according to the inventive concept will now be described more fully with reference to accompanying drawings.

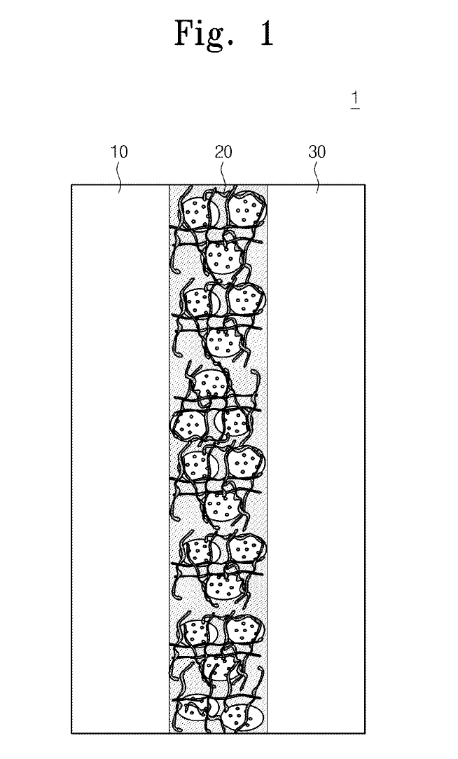

FIG. 1 is a cross-sectional view of a lithium battery according to an embodiment of the inventive concept.

Referring to FIG. 1, a lithium battery 1 may include an anode 10 and a cathode 30 spaced to face each other and an organic/inorganic hybrid electrolyte 20 disposed between the anode 10 and the cathode 30. The anode 10 may include an anode active material and an anode collector. The organic/inorganic hybrid electrolyte 20 may serve as a path along which ions travel between the anode 10 and the cathode 30. The organic/inorganic hybrid electrolyte 20 may be in a solid state and in the form of film.

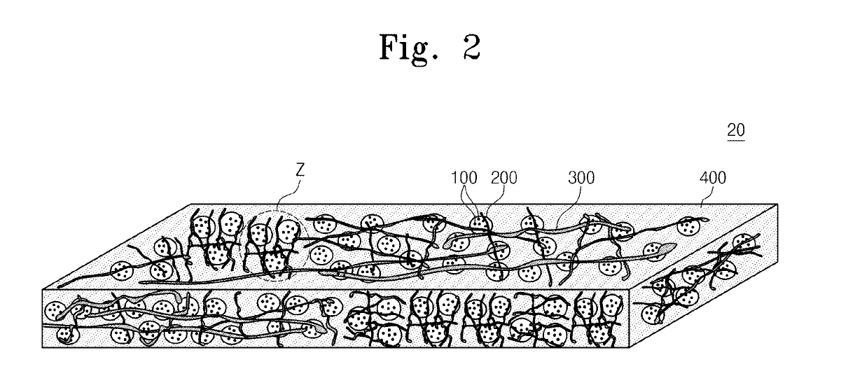

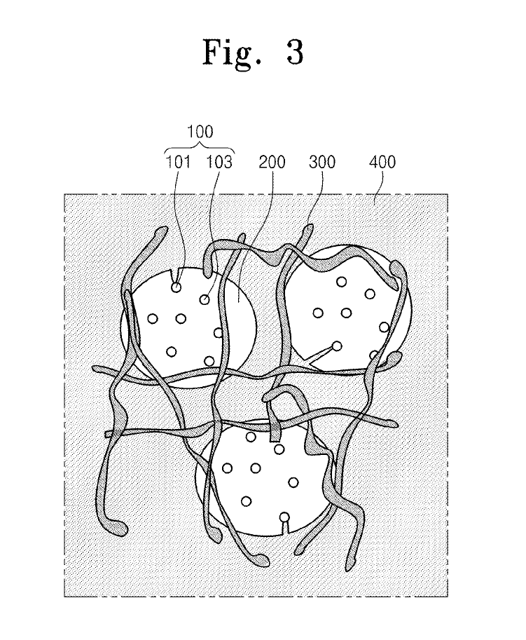

FIG. 2 is a cross-sectional view of an organic/inorganic hybrid electrolyte according to an embodiment of the inventive concept, and FIG. 3 is an enlarged view of a Z region in FIG. 2. An organic/inorganic hybrid electrolyte according to an embodiment of the inventive concept will now be described below in detail with reference to FIGS. 2 and 3 together with FIG. 1.

Referring to FIGS. 2 and 3, an organic/inorganic hybrid electrolyte 20 may include inorganic particles 100, a first polymer 200 surrounding the inorganic particles 100, a second polymer 300 surrounding the first polymer 200, and an organic solution 400.

The inorganic particles 100 may be distributed in the first polymer 200. The inorganic particles 100 may include a first particle 101 and a second particle 103. The first particle 101 and the second particle 103 may be spaced apart from each other. The inorganic particles 100 may include, for example, Lithium Aluminum Titanium Phosphate (LATP), Lithium Aluminum Germanium Phosphate (LAGP), Lithium Lanthanum Zirconium Oxide (LLZO) or Lithium Lanthanum Titanium Oxide (LLTO).

Each of the inorganic particles 100 may have a size ranging from about 500 nanometers to 50 micrometers. Due to the inorganic particles 100, the organic/inorganic hybrid electrolyte 20 may have improved mechanical strength and ensure stability.

When the inorganic particles 100 are arranged adjacent to or in contact with each other in the organic/inorganic hybrid electrolyte 20, they may be in an idle state. The idle state may mean that the inorganic particles 100 do not contribute to ion transfer at the organic/inorganic hybrid electrolyte 20. In the inventive concept, since the inorganic particles 100 are distributed to be provided, they may contribute to ion transfer at the organic/inorganic hybrid electrolyte 20. For example, the inorganic particles 100 may come in contact with the first polymer 200 to transfer ions to the organic solution 400 through the first polymer 200 and receive ions through the first polymer 200. As another example, the inorganic particles 100 may transfer ions to the organic solution 400 through the first polymer 200 and the second polymer 300 and receive ions through the first polymer 200 and the second polymer 300. As an alternative example, the inorganic particles 100 may come in direct contact with the organic solution 400 to directly transfer ions to the organic solution 400 and receive ions from the organic solution 400. As the content of the first polymer 200, the second polymer 300, and the organic solution 400 is adjusted in the organic/inorganic hybrid electrolyte 20, surface activation energy of the inorganic particles 100 may be controlled. Thus, ion mobility may be adjusted at the boundary of the inorganic particles 100 such that the ions travel by passing through the inorganic particles 100 in the organic/inorganic hybrid electrolyte 300. The organic/inorganic hybrid electrolyte 20 may have high ionic conductivity while ensuring stability and mechanical strength.

The first polymer 200 may come in contact with the inorganic particles due to its excellent binding force to the inorganic particles. The first polymer 200 may come in contact with the second polymer 300 and/or the organic solution 400. The first polymer 200 may be involved in ion transfer of the inorganic particles 100. For example, the first polymer 200 may transfer ions to the inorganic particles 100 or receive ion from the inorganic particles 100. The first polymer 200 may include vinylidene fluoride-based polymer, e.g., polyvinylidene fluoride, a copolymer of vinylidene fluoride and hexafluoropropylene, a copolymer of vinylidene fluoride and trifluoro ethylene or a copolymer of vinylidene fluoride and tetrafluoroethylene. The first polymer 200 may serve to improve film formability of the organic/inorganic hybrid electrolyte 20.

The second polymer 300 may have a network structure where chains are entangled and intersect each other. The second polymer 300 may come in contact with the first polymer 200 and/or the organic solution 400. The second polymer 300 may be involved in ion transfer between the organic solution 400 and the inorganic particles 100. The second polymer 300 may include cellulosic polymer, e.g., cellulose, cellulose, ethyl cellulose, butyl cellulose, carboxymethyl cellulose or hydroxypropyl cellulose. The first polymer 200 and the second polymer 300 may have a weight ratio of 1:99 to 99:1. The weight ratio of the first polymer 200 and the second polymer 300 may be controlled.

The organic solution 400 may be provided between the inorganic particles 100 and the first polymer 200, between the inorganic particles 100 and the second polymer 300 or between the first polymer 200 and the second polymer 300. The organic solution 400 may be in contact with at least one of the inorganic particles 100, the first polymer 200, and the third polymer 300. The organic solution 400 may have high ionic conductivity. The organic solution 400 may serve to transfer ions in the organic/inorganic hybrid electrolyte 20 during driving of the lithium battery 1 and may be provided as an ion transfer path. The organic solution 400 may include an organic solvent and lithium salt. The organic solution 400 may include ethylene carbonate, propylene carbonate, ethyl methyl carbonate, gamma-butyrolactone, triglyme, ethylene glycol, ethylene oxide, ethylene oxide dimethyl ether or a combination thereof. The lithium salt may be selected from the group consisting of lithium perchlorate (LiClO₄), lithium triplate (LiCF₃SO₃), lithium hexafluorophosphate (LiPF₆), lithium tetrafluoroborate (LiBF₄), lithium trifluoromethane sulfonyl imide (LiN(CF₃SO₂)₂), and combinations thereof.

Hereinafter, a method for preparing an organic/inorganic hybrid electrolyte according to an embodiment of the inventive concept will now be described below in detail.

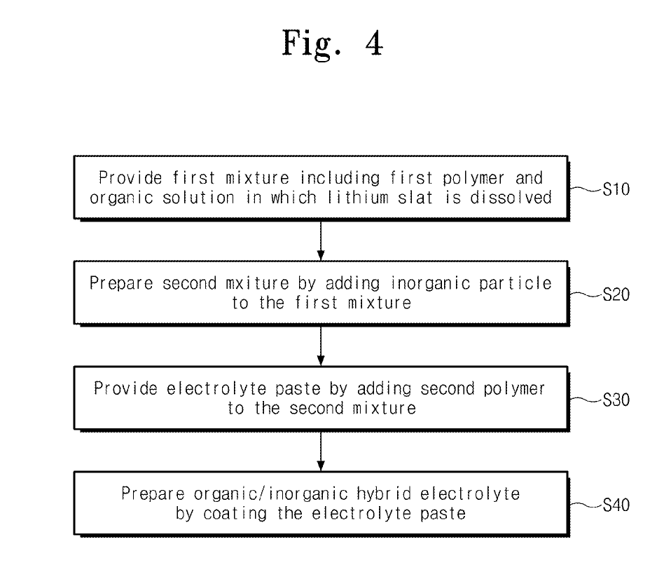

FIG. 4 is a flowchart illustrating a method for preparing an organic/inorganic hybrid electrolyte according to an embodiment of the inventive concept. A method for preparing an organic/inorganic hybrid electrolyte according to an embodiment of the inventive concept will now be described below in detail with reference to FIG. 4 together with FIGS. 1 to 3.

Referring to FIG. 4, a first mixture including a first polymer 200 and an organic solution 400 may be prepared (S 10). The first polymer 200 may be a vinylidene fluoride-based polymer explained as an example of FIGS. 1 and 2. The first polymer 200 may be dissolved in a solvent, and the organic solution 400 may be added to the first polymer 200. The solvent may be a cosolvent such as N-methylpyrrolidone (NMP). The organic solution 400 may be filled in between a first polymer 200 and a first polymer 200. The organic solution 400 may include an organic solvent and lithium salt. The organic solvent may include ethylene carbonate, propylene carbonate, ethyl methyl carbonate, gamma-butyrolactone, triglyme, ethylene glycol, ethylene oxide, ethylene oxide dimethyl ether or a combination thereof. The lithium salt may be selected from the group consisting of lithium perchlorate (LiClO₄), lithium triplate (LiCF₃SO₃), lithium hexafluorophosphate (LiPF₆), lithium tetrafluoroborate (LiBF₄), lithium trifluoromethane sulfonyl imide (LiN(CF₃SO₂)₂), and combinations thereof. The first mixture may have a viscosity of about 1000 cP.

An electrolyte paste may be prepared by adding a second polymer 300 to the second mixture (S30). The second polymer 300 may be a cellulose polymer explained as an example in FIGS. 1 and 2. The second polymer 300 may have a network structure where chains intersect each other and may be formed to surround and bind the first polymer 200. The first polymer 200 and the second polymer 300 may be mixed at a weight ratio of about 1:99 to about 99:1. The organic solution containing the dissolved lithium salt may be included in the electrolyte paste to have about 100 to about 800 percent by weight to the first polymer 200 and the second polymer 300. The inorganic particles 100 may be included in the electrolyte paste to have about 1 to about 2000 percent by weight to the first polymer 200 and the second polymer 300.

The organic/inorganic hybrid electrolyte 20 may be prepared in the form of film by casting the electrolyte paste on a substrate (S40). The organic/inorganic hybrid electrolyte 20 may be prepared to a thickness of about 1 to about 200 nanometers. The thickness of the organic/inorganic hybrid electrolyte 20 may be adjusted by controlling the concentration and composition of the electrolyte paste. For example, by adjusting a content ratio of the inorganic particles 100, the electrolyte paste may be prepared to have viscosity that is applicable to the casting process. The substrate may be an anode 10 or a cathode 30, and the electrolyte paste may be directly coated on the anode 10 or the cathode 30. In another exemplary embodiment of the inventive concept, the organic/inorganic hybrid electrolyte 20 may be prepared on the substrate and provided after being separated from the substrate. The organic/inorganic hybrid electrolyte 20 may be completed by the above-described embodiment.

Hereinafter, a method of preparing an organic/inorganic hybrid electrolyte according to the inventive concept and a characteristic evaluation result thereof will now be described in detail with reference to experiment examples.

### Preparation of Organic/Inorganic Hybrid Electrolyte

### Experiment Example 1

(Preparation of Organic/Inorganic Hybrid Electrolyte Paste)

A copolymer of vinylidene fluoride and hexafluoropropylene is added to N-methylpyrrolidone (NMP). Then, lithium aluminum titanium phosphate (LATP) and an organic solution are sequentially added. The organic solution may be prepared to have a concentration of 1 mol by dissolving lithium hexafluorophosphate (LiPF6) in an organic solvent in which ethylene carbonate (EC) and propylene carbonate (PC) are mixed at a weight ratio of 1:1. Ethyl cellulose may be added. The ethyl cellulose and the copolymer may have percent by weight of 30:70. The organic solution may be added to have about 300 percent by weight of the ethyl cellulose and the copolymer, and lithium aluminum titanium phosphate (LATP) may be added to have about 30 percent by weight of the ethyl cellulose and the copolymer.

(Preparation of Organic/Inorganic Hybrid Electrolyte)

An organic/inorganic hybrid electrolyte having a thickness of about 100 micrometers may be prepared by casting the prepared electrolyte paste. The organic/inorganic hybrid electrolyte may be prepared in the form of film.

(Performance Evaluation of Organic/Inorganic Hybrid Electrolyte Film)

An organic/inorganic hybrid electrolyte film is disposed between stainless steel (SUS) electrodes each having an area of 2 cm×2 cm. Impedance of the organic/inorganic hybrid electrolyte film may be measured at a frequency ranging from abut 1 Hz to about 1 MHz and an AC amplitude of about 50 mV.

### Experiment Example 2

An organic/inorganic hybrid electrolyte may be prepared in the same manner as described in the first experiment example. However, ethyl cellulose and a copolymer may be mixed to have percent by weight (wt %) of 50:50.

### Experiment Example 3

An organic/inorganic hybrid electrolyte may be prepared in the same manner as described in the experiment example. However, ethyl cellulose and a copolymer may be mixed to have percent by weight (wt %) of 70:30.

### Experiment Example 4

An organic/inorganic hybrid electrolyte may be prepared in the same manner as described in the first experiment example. However, ethyl cellulose and a copolymer may be mixed to have percent by weight (wt %) of 90:10.

### Comparison Example

Performance evaluation of an organic/inorganic hybrid electrolyte may be conducted in the same manner as described in the first experiment example. However, the organic/inorganic hybrid electrolyte may be prepared in the form of pellet using lithium aluminum titanium phosphate (LATP). The measurement of impedance may be conducted in the same manner using a lithium electrode.

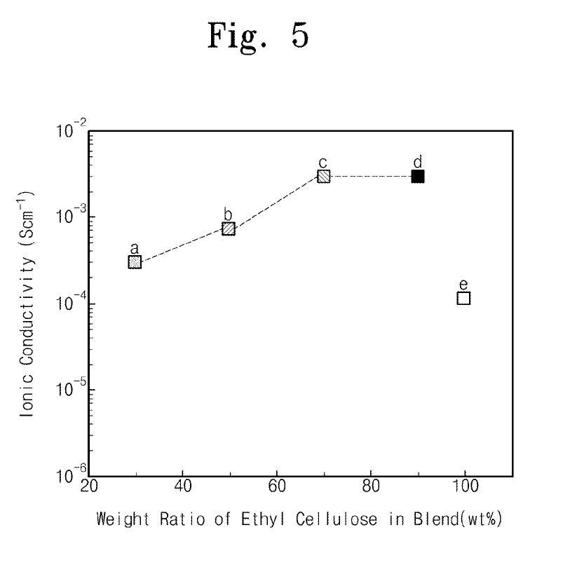

FIG. 5 is a graph showing a result of evaluating ionic conductivity characteristics of the experiment examples and the comparison example. In FIG. 5, an x-axis represents a weight ratio of ethylene cellulose (second polymer) in a blend of a copolymer of vinylidene fluoride and hexafluoropropylene (first polymer) and ethyl cellulose (second polymer), and a y-axis represents ionic conductivity of the prepared organic/inorganic hybrid electrolyte 20. Hereinafter, the result will now be described with reference to FIG. 5 together with FIGS. 1 to 3.

Referring to FIG. 5, it would be understood that the first experiment example (a), the second experiment example (b), the third text example (c), and the fourth experiment example (d) have higher ionic conductivity than the comparison example (e). As the first polymer 200 and the second polymer 300 are included in the first to fourth experiment examples (a), (b), (c), and (d), ions may be transferred through the inorganic particles 100 in the organic/inorganic hybrid electrolyte 20. Ionic conductivity of the organic/inorganic hybrid electrolyte 20 may be enhanced. As the contents of the first polymer 200 and the second polymer 300 in the organic/inorganic hybrid electrolyte 20 are adjusted, surface activation energy of the inorganic particles 100 may be controlled. Thus, an ion transfer path of the organic/inorganic hybrid electrolyte 20 may be adjusted.

As described so far, an organic/inorganic hybrid electrolyte according to the inventive concept includes inorganic particles, a first polymer surrounding the inorganic particles, a second polymer having a network structure and surrounding the first polymer, and an organic solution. Due to the first polymer, the inorganic particles are distributed to come in contact with the organic solution or the first polymer. As the inorganic particles are distributed to be provided, they can be involved in transferring ions in the organic/inorganic hybrid electrolyte. The organic/inorganic hybrid electrolyte can have high ionic conductivity while ensuring stability and mechanical strength.

While the inventive concept has been particularly shown and described with reference to exemplary embodiments thereof, it will be apparent to those of ordinary skill in the art that various changes in form and detail may be made therein without departing from the spirit and scope of the inventive concept as defined by the following claims.

What is claimed is:

1. An organic/inorganic hybrid electrolyte comprising:
a first polymer surrounding distributed inorganic particles;
a second polymer having a network structure where chains are entangled and intersect each other; and
an organic solution supplied between the first polymer and the second polymer,
wherein the second polymer surrounds and binds the first polymer.

2. The organic/inorganic hybrid electrolyte of claim 1, wherein the inorganic particles include a first particle and a second particle that are spaced apart from each other.

3. The organic/inorganic hybrid electrolyte of claim 1, wherein the inorganic particles are in contact with at least one of the first polymer and the organic solution.

4. The organic/inorganic hybrid electrolyte of claim 1, wherein the first polymer is in contact with the inorganic particles and the second polymer and connects the inorganic to the second polymer.

5. The organic/inorganic hybrid electrolyte of claim 1, wherein the first polymer includes a vinylidene fluoride-based polymer, a copolymer of vinylidene fluoride and hexafluoropropylene, a copolymer of vinylidene fluoride and trifluoro ethylene or a copolymer of vinylidene fluoride and tetrafluoroethylene, and
wherein the second polymer includes cellulose, cellulose, ethyl cellulose, butyl cellulose, carboxymethyl cellulose or hydroxypropyl cellulose.

6. The organic/inorganic hybrid electrolyte of claim 1, wherein the organic solution includes lithium salt and an organic solvent.

7. A method for preparing an organic/inorganic hybrid electrolyte, comprising:
preparing a first mixture by mixing a first polymer with an organic solution containing dissolved lithium salt;
preparing a second mixture by adding organic particles to the first mixture;
preparing an electrolyte paste by adding a second polymer to the second mixture; and
forming an electrolyte film by coating the electrolyte paste on a substrate,
wherein the second polymer has a network structure where chains intersect each other and binds the first polymer.

8. The method of claim 7, wherein the inorganic particles are distributed in the first polymer and are in contact with at least one of the first polymer and the organic solution.

9. The method of claim 7, wherein preparing an electrolyte paste comprises filling the organic solution containing the dissolved lithium salt in between the first polymer and the second polymer.

10. The method of claim 7, wherein the second mixture has higher viscosity than the first mixture.

11. The method of claim 7, wherein preparing an electrolyte paste comprises mixing a second polymer such that the first polymer and the second polymer have a weight ratio of 1:99 to 99:1.

12. The method of claim 7, wherein the inorganic particles are added to have 1 to 2000 percent by weight to the first polymer and the second polymer, and
wherein the organic solution containing the dissolved lithium salt is added to have 1 to 800 percent by weight to the first polymer and the second polymer.

13. A lithium battery comprising:
an anode;
a cathode spaced to face the anode; and
an organic/inorganic hybrid electrolyte disposed between the anode and the cathode,
wherein the organic/inorganic hybrid electrolyte comprises:
inorganic particles including a first particle and a second particle that are spaced apart from each other;
a vinylidene fluoride-based polymer surrounding the inorganic particles;
a cellulose-based polymer having a network structure where chains are entangled and surrounding and binding the vinylidene fluoride-based polymer; and
an organic solution containing dissolved lithium salt filled in between the vinylidene fluoride-based polymer and the cellulose-based polymer.

14. The lithium battery of claim 13, wherein the inorganic particles are in contact with at least one of the cellulose-based polymer and the organic solution containing the dissolved lithium salt.

15. The lithium battery of claim 13, wherein the cellulose-based polymer connects the inorganic particles to the vinylidene fluoride-based polymer.

16. The lithium battery of claim 13, wherein the organic solution containing the dissolved lithium salt is further filled in between the inorganic particles and the vinylidene fluoride-based polymer and between the inorganic particles and the cellulose-based polymer.

17. The lithium battery of claim 13, wherein the organic/inorganic hybrid electrolyte is provided in the form of film.

18. The lithium battery of claim 13, wherein the vinylidene fluoride-based polymer includes a vinylidene fluoride-based polymer, a copolymer of vinylidene fluoride and hexafluoropropylene, a copolymer of vinylidene fluoride and trifluoro ethylene or a copolymer of vinylidene fluoride and tetrafluoroethylene, and
wherein the cellulose-based polymer includes cellulose, cellulose, ethyl cellulose, butyl cellulose, carboxymethyl cellulose or hydroxypropyl cellulose.
